(19) United States
(12) Patent Application Publication
(10) Pub. No.: US 2014/0223366 A1
(43) Pub. Date: Aug. 7, 2014

(54) INFORMATION PROCESSING APPARATUS, IMAGE PROCESSING APPARATUS, COMPUTER READABLE MEDIUM, AND INFORMATION PROCESSING METHOD

(71) Applicant: FUJI XEROX CO., Ltd., Tokyo (JP)

(72) Inventor: Koichi SATO, Kanagawa (JP)

(73) Assignee: FUJI XEROX CO., Ltd., Tokyo (JP)

(21) Appl. No.: 14/012,233

(22) Filed: Aug. 28, 2013

(30) Foreign Application Priority Data
Feb. 6, 2013 (JP) 2013-021607

(51) Int. Cl. G06F 3/0482

(52) U.S. Cl. CPC G06F 3/0482
USPC 715/810

(57) ABSTRACT

An information processing apparatus includes: a moving operation detector that detects a moving operation of moving a function display element while pointing the function display element with a pointing unit, on a display screen displaying the function display element representing a function of the apparatus; an acquiring unit that acquires plural setting information items for a setting item of the function in accordance with the detection of the moving operation by the moving operation detector; a display that displays on the display screen the plural setting display elements representing the plural setting information items; and a setting unit that, in accordance with the detection by the moving operation detector that the function display element has reached a position on one of the plural setting display elements, sets the setting information item represented by the setting display element for the setting item of the function.

### CROSS-REFERENCE TO RELATED APPLICATIONS

This application is based on and claims priority under 35 USC 119 from Japanese Patent Application No. 2013-021607 filed Feb. 6, 2013.

### BACKGROUND

1. Technical Field

The present invention relates to an information processing apparatus, an image processing apparatus, a computer readable medium, and an information processing method.

2. Summary

According to an aspect of the invention, there is provided an information processing apparatus including a moving operation detector, an acquiring unit, a display, and a setting unit. The moving operation detector detects a moving operation of moving a function display element while pointing the function display element with a pointing unit, on a display screen displaying the function display element being a display element representing a function of the apparatus. The acquiring unit acquires plural setting information items for a setting item of the function in accordance with the detection of the moving operation by the moving operation detector. The display displays on the display screen the plural setting display elements being plural display elements representing the plural setting information items. In accordance with the detection by the moving operation detector that the function display element has reached a position on one of the plural setting display elements, the setting unit sets the setting information item represented by the setting display element for the setting item of the function.

### BRIEF DESCRIPTION OF THE DRAWINGS

An exemplary embodiment of the present invention will be described in detail based on the following figures, wherein:

FIG. 1 is a diagram illustrating a configuration example of an image processing apparatus to which the exemplary embodiment of the invention is applied;

FIG. 2 is a diagram illustrating content displayed on an operation panel when displaying function icons;

FIG. 3 is a diagram illustrating content displayed on the operation panel when displaying an item selection screen in accordance with a common method;

FIG. 4 is a diagram illustrating content displayed on the operation panel when displaying a parameter selection screen in accordance with a common method;

FIG. 5 is a diagram illustrating content displayed on the operation panel when a function icon starts being dragged in the exemplary embodiment of the invention;

FIG. 6 is a diagram illustrating content displayed when the function icon is dragged onto a parameter icon in the exemplary embodiment of the invention;

FIG. 7 is a diagram illustrating content displayed when the function icon is being dragged over plural parameter icons in the exemplary embodiment of the invention;

FIG. 8 is a block diagram illustrating a functional configuration example of the image processing apparatus in the exemplary embodiment of the invention;

FIG. 9 is a flowchart illustrating an operation example performed when the image processing apparatus in the exemplary embodiment of the invention displays parameter icons; and

FIG. 10 is a flowchart illustrating an operation example performed when the image processing apparatus in the exemplary embodiment of the invention sets a parameter.

### DETAILED DESCRIPTION

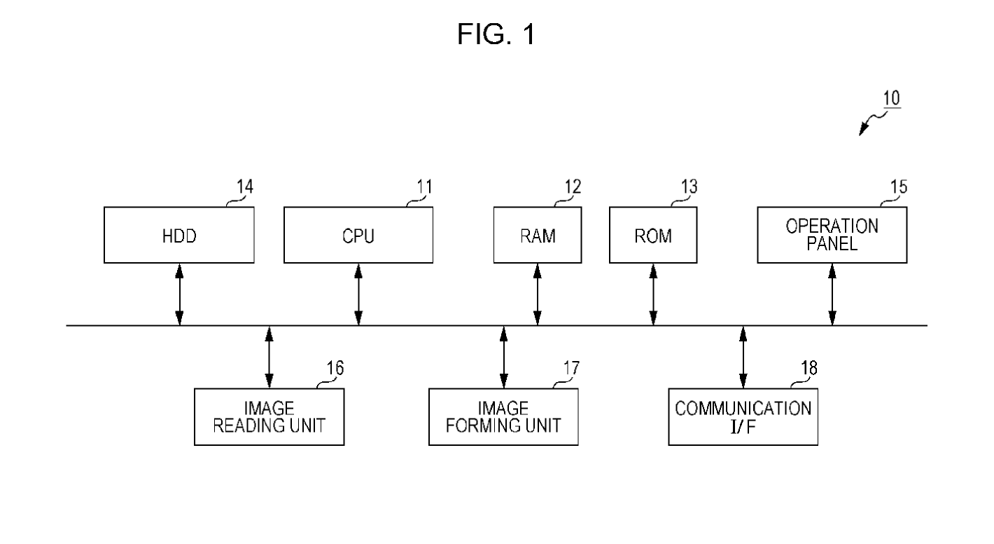

An exemplary embodiment of the present invention will be described in detail below with reference to the accompanying drawings. FIG. 1 is a diagram illustrating a hardware configuration example of an image processing apparatus 10 to which the present exemplary embodiment is applied. As illustrated in the drawing, the image processing apparatus 10 includes a central processing unit (CPU) 11, a random access memory (RAM) 12, a read only memory (ROM) 13, a hard disk drive (HDD) 14, an operation panel 15, an image reading unit 16, an image forming unit 17, and a communication interface (hereinafter designated as “communication I/F”) 18.

The CPU 11 loads a variety of programs stored in the ROM 13 or the like into the RAM 12 and executes the programs, to thereby realize later-described functions. The RAM 12 is a memory used as a working memory or the like of the CPU 11. The ROM 13 is a memory that stores, for example, the variety of programs executed by the CPU 11. The HDD 14 is, for example, a magnetic disk device that stores image data read by the image reading unit 16, image data for use in image formation executed by the image forming unit 17, and so forth. The operation panel 15 is a touch panel that displays a variety of information and receives operation inputs performed by a user. Herein, the operation panel 15 includes a display and a position detecting sheet. The display is an example of a display screen on which the variety of information is displayed. The position detecting sheet detects the position pointed by a pointing unit, such as a finger or a stylus pen.

The image reading unit 16, which is an example of an image processing unit, reads an image recorded on a recording medium, such as a sheet of paper. Herein, the image reading unit 16 is a scanner, for example. The image reading unit 16 may employ a CCD system in which light is radiated onto a document from a light source, reflected by the document, reduced by a lens, and received by charge coupled devices (CCDs) or a CIS system in which beams of light are sequentially radiated onto a document from light emitting diode (LED) light sources, reflected by the document, and received by a contact image sensor (CIS).

The image forming unit 17, which is an example of an image processing unit, forms an image on a recording medium. Herein, the image forming unit 17 is a printer, for example. The image forming unit 17 may employ an electrophotographic system that forms an image by transferring toner adhering to a photoconductor onto a recording medium or an inkjet system that forms an image by ejecting ink onto a recording medium. The communication I/F 18 transmits and receives a variety of information to and from another device via a network.

In such an image processing apparatus 10, it is possible to set parameters for plural setting items of a function represented by a function icon displayed on the operation panel 15. To set parameters for each function, however, it is commonly necessary to perform an operation of touching a function icon to display an item selection screen for selecting a setting item of the function, and further displaying within the item selection screen a parameter selection screen for selecting a parameter. Therefore, the setting operation is troublesome.

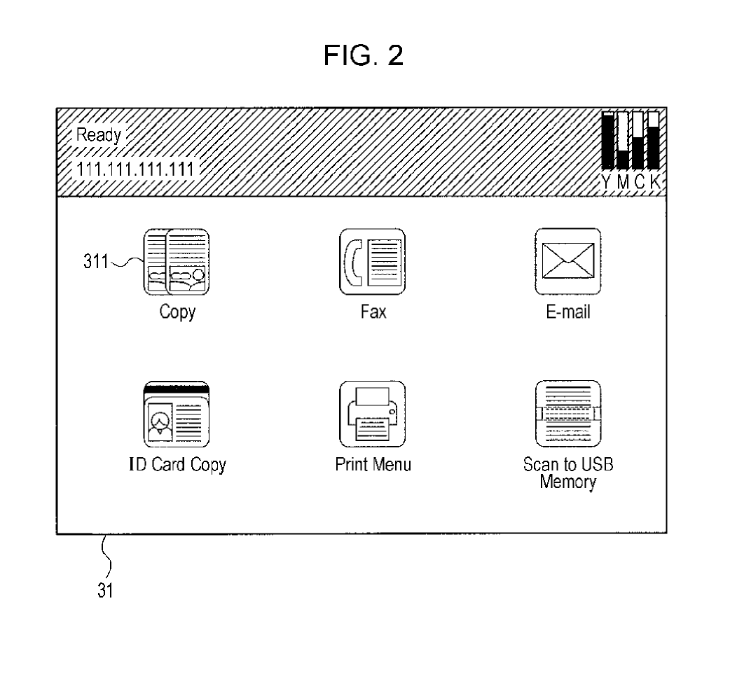

For example, it is now assumed that a function icon for copy (copy icon), for which a parameter “full color” has been set as a default value for a setting item “color mode,” is displayed on the operation panel 15. FIG. 2 is a diagram illustrating content displayed on the operation panel 15 in this case. In the drawing, a menu screen 31 on the operation panel 15 displays six function icons including a copy icon 311. According to the above-described common method, a user is required to perform the following steps to execute copy by setting a parameter “monochrome” for the setting item “color mode” with the use of the copy icon 311.

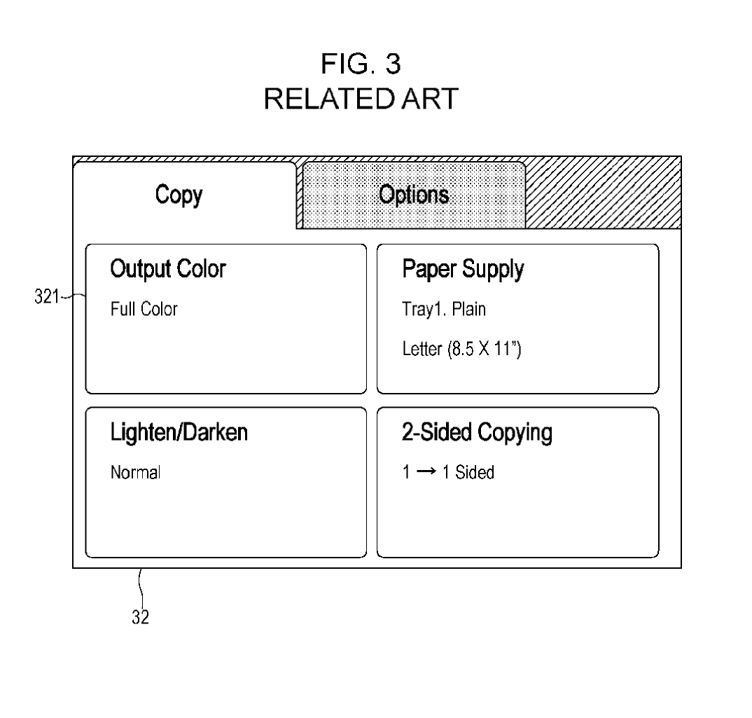

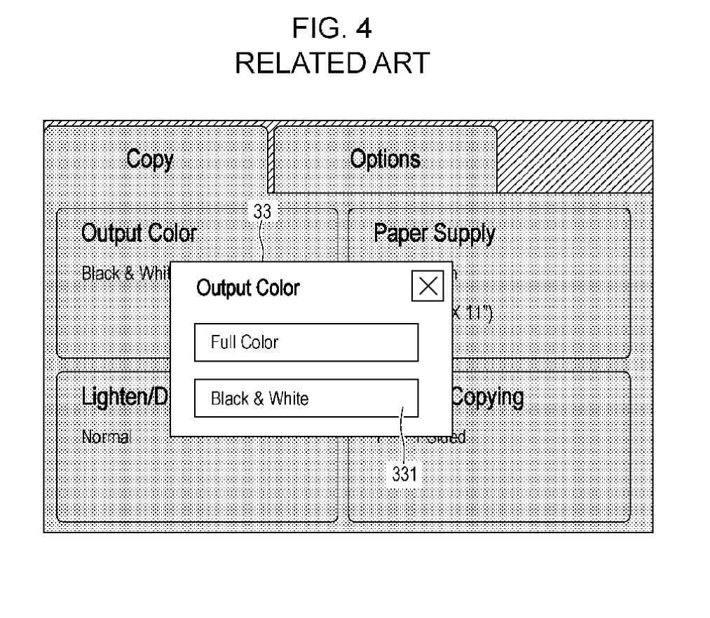

Firstly, the user touches the copy icon 311 to display an item selection screen for selecting a setting item of copy. FIG. 3 is a diagram illustrating content displayed on the operation panel 15 in this case. In the drawing, an item selection screen 32 on the operation panel 15 displays four item icons including an item icon 321 (designated as “Output Color”) representing the setting item “color mode.”Secondly, the user touches the item icon 321 on the item selection screen 32 to display a parameter selection screen for selecting a parameter for the setting item “color mode.” FIG. 4 is a diagram illustrating content displayed on the operation panel 15 in this case. In the drawing, a parameter selection screen 33 on the operation panel 15 displays two parameter icons including a parameter icon 331 (designated as “Black & White”) representing the parameter “monochrome.” Thirdly, the user touches the parameter icon 331 on the parameter selection screen 33 to set the parameter “monochrome” for the setting item “color mode.” Fourthly, the user presses a copy button (not illustrated) provided to the image processing apparatus 10. That is, the above-described common method involves many steps to perform.

In the present exemplary embodiment, therefore, when a user starts a drag operation of moving a function icon for copy, fax, scan, or the like while holding the function icon with a hand or the like, a parameter area is displayed which includes parameter icons representing parameters for a setting item of the function represented by the function icon. Then, the user drags the function icon onto one of the parameter icons to set the parameter represented by the parameter icon for the setting item. Further, if the function represented by the function icon includes plural setting items, parameter icons representing parameters for the respective setting items are sequentially displayed. Accordingly, the user is allowed to sequentially drag the function icon over, among these parameter icons, parameter icons representing parameters which the user desires to use. Having dragged the function icon over all of the parameter icons representing the parameters which the user desires to change, the user performs a drop operation of releasing the hand or the like holding the function icon from the operation panel 15. Thereby, the setting items corresponding to the parameter icons, over which the function icon has passed, use the respective parameters represented by the parameter icons, and the other setting items use respective default parameters set for the function icon. Then, the function allocated to the function icon is executed.

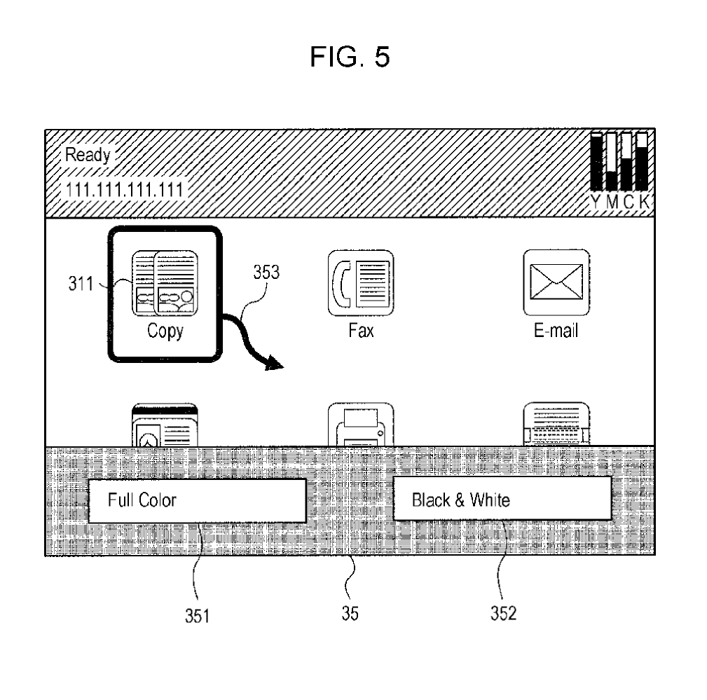

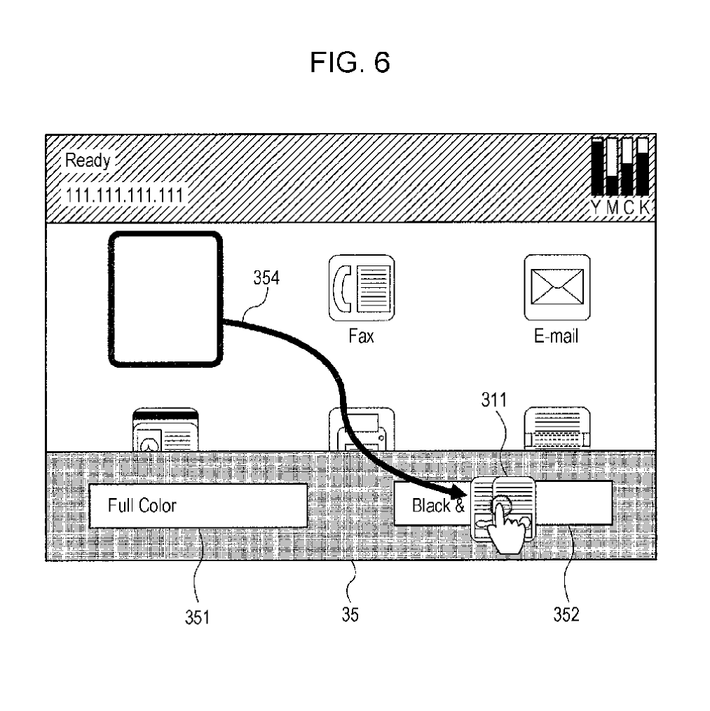

For example, if a user starts dragging the copy icon 311 on the operation panel 15 illustrated in FIG. 2, a parameter area including parameter icons representing parameters for a setting item of copy is displayed on the operation panel 15. FIG. 5 is a diagram illustrating content displayed on the operation panel 15 in this case. In the drawing, when the copy icon 311 starts being dragged on the operation panel 15, as indicated by an arrow 353, a parameter area 35 is displayed to expand from the lower side of the operation panel 15. The parameter area 35 includes, as parameter icons representing parameters for the setting item “color mode,” a parameter icon 351 (designated as “Full Color”) representing a parameter “full color” and a parameter icon 352 (designated as “Black & White”) representing a parameter “monochrome.” Then, it is assumed that the user has dragged and dropped the copy icon 311 onto the parameter icon 352 on the operation panel 15 illustrated in FIG. 5. FIG. 6 is a diagram illustrating content displayed on the operation panel 15 in this case. In the drawing, the copy icon 311 has been dragged and dropped onto the parameter icon 352 representing the parameter “monochrome” on the operation panel 15, as indicated by an arrow 354. Thereby, the parameter “monochrome” is set for the setting item “color mode” of copy, and copy is executed with the set parameter “monochrome.”

In the above-described example, the parameter area 35 includes only the parameter icons representing the parameters for the setting item “color mode.” This is a simple user interface based on the assumption that the parameters for the setting items other than the setting item “color mode” are not to be changed from respective default values. The parameters not to be changed from the default values may be determined in accordance with a standard preset in the image processing apparatus 10 or preset by an administrator of the image processing apparatus 10. Normally, however, a function includes plural setting items, such as layout and image quality. In the present exemplary embodiment, therefore, the parameter area includes parameter icons representing parameters for plural setting items to allow the parameters for the plural setting items to be changed from respective default values. In this case, the present exemplary embodiment further provides a function of increasing or reducing the size of the parameter area in accordance with the position of the parameter icon in the parameter area at which the function icon is present. Further, the parameters represented by the parameter icons located on the path on which the function icon has been dragged to be dropped are used as the parameters to be set for the plural setting items. In this case, the setting items corresponding to the parameter icons not located on the path on which the function icon has been dragged use respective default parameters.

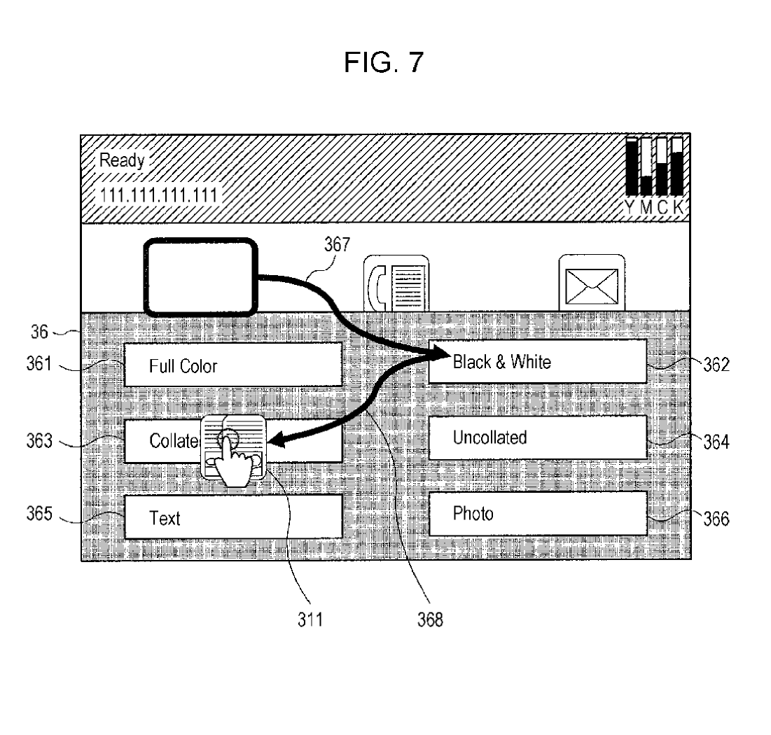

FIG. 7 is a diagram illustrating content displayed on the operation panel 15 in this case. In the drawing, a parameter area 36 is displayed on the operation panel 15 to expand from the lower side of the operation panel 15. The parameter area 36 includes, as parameter icons representing parameters for a setting item “color mode,” a parameter icon 361 (designated as “Full Color”) representing a parameter “full color” and a parameter icon 362 (designated as “Black & White”) representing a parameter “monochrome.” The parameter area 36 further includes, as parameter icons representing parameters for a setting item “collation,” a parameter icon 363 (designated as “Collated”) representing a parameter “collated” and a parameter icon 364 (designated as “Uncollated”) representing a parameter “uncollated.” The parameter area 36 further includes, as parameter icons representing parameters for a setting item “image quality,” a parameter icon 365 (designated as “Text”) representing a parameter “text” and a parameter icon 366 (designated as “Photo”) representing a parameter “photograph.” Further, the copy icon 311 is dragged onto the parameter icon 362 representing the parameter “monochrome,” as indicated by an arrow 367. Subsequently, the copy icon 311 is dragged and dropped onto the parameter icon 363 representing the parameter “collated,” as indicated by an arrow 368. Thereby, the parameter “monochrome” is set for the setting item “color mode,” and the parameter “collated” is set for the setting item “collation.” For the other setting items, respective parameters previously set for the copy icon 311 are set.

As illustrated in FIG. 7, if a function includes plural setting items, the parameter area 36 may be configured to shrink downward as the function icon being dragged is moved toward an upper portion of the parameter area 36, and to expand upward as the function icon being dragged is moved toward a lower portion of the parameter area 36. In this case, the parameter area 36 is an example of a display area which hides a portion of the display screen from a first side corresponding to one side of the display screen to a second side located between the one side of the display screen and an opposite side of the display screen opposite to the one side, and which is increased in area as the second side moves away from the first side in accordance with the movement of a function display element from the second side toward the first side. More specifically, the lower side of the operation panel 15 is an example of the one side of the display screen, and the upper side of the operation panel 15 is an example of the opposite side of the display screen. Further, the lower side of the parameter area 36 is an example of the first side of the display area, and the upper side of the parameter area 36 is an example of the second side of the display area. It is also conceivable to configure the display area as another exemplary embodiment in which the display area shrinks upward and expands downward, shrinks leftward and expands rightward, or shrinks rightward and expands leftward. The shrinking direction and the expanding direction may be determined in accordance with, for example, which one of the upper side, the lower side, the left side, and the right side of the operation panel 15 corresponds to the position from which the function icon starts being dragged.

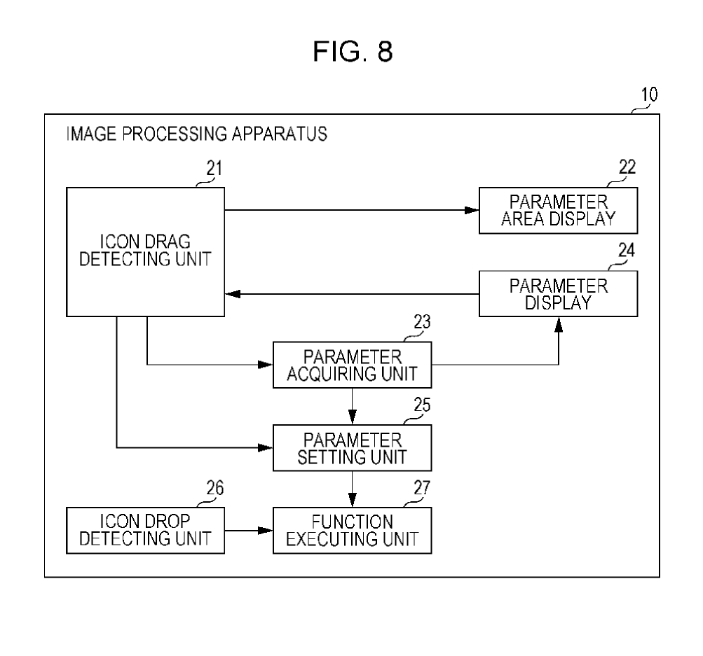

A configuration of the image processing apparatus 10 realizing such an operation will now be described. FIG. 8 is a block diagram illustrating a functional configuration example of the image processing apparatus 10. As illustrated in the drawing, the image processing apparatus 10 includes an icon drag detecting unit 21, a parameter area display 22, a parameter acquiring unit 23, a parameter display 24, a parameter setting unit 25, an icon drop detecting unit 26, and a function executing unit 27.

The icon drag detecting unit 21 detects a user operation of dragging a function icon on the operation panel 15. When the function icon starts being dragged, the icon drag detecting unit 21 notifies the parameter area display 22 and the parameter acquiring unit 23 that the function icon has started being dragged. Further, the icon drag detecting unit 21 is notified of the display position of each of the parameter icons by the parameter display 24, and compares the display position of the parameter icon with the display position of the function icon, to thereby determine whether or not the function icon has been dragged onto the parameter icon. If the function icon has been dragged onto the parameter icon, the icon drag detecting unit 21 notifies the parameter setting unit 25 that the function icon has been dragged onto the parameter icon. In the present exemplary embodiment, the function icon is used as an example of the function display element, which is a display element representing a function. Further, the drag operation is used as an example of a moving operation of moving the function display element while pointing the function display element with the pointing unit. Further, the icon drag detecting unit 21 is provided as an example of a moving operation detector that detects the moving operation.

Notified by the icon drag detecting unit 21 that the function icon has started being dragged, the parameter area display 22 displays a parameter area on the operation panel 15.

Notified by the icon drag detecting unit 21 that the function icon has started being dragged, the parameter acquiring unit 23 identifies a setting item of the function represented by the function icon, and acquires the parameters for the setting items. In this process, the parameter acquiring unit 23 may identify one or more of plural setting items of the function represented by the function icon in accordance with a preset standard and acquire the parameters for the setting items. Further, the parameter acquiring unit 23 transmits the acquired parameters to the parameter display 24 and the parameter setting unit 25. In the present exemplary embodiment, the parameters are used as an example of setting information items for a setting item of a function, and the parameter acquiring unit 23 is provided as an example of an acquiring unit that acquires plural setting information items.

The parameter display 24 displays, in the parameter area on the operation panel 15, parameter icons representing the parameters transmitted from the parameter acquiring unit 23. Further, the parameter display 24 transmits the display positions of the parameter icons on the operation panel 15 to the icon drag detecting unit 21. In the present exemplary embodiment, the parameter icons are used as an example of setting display elements, which are display elements representing the setting information items, and the parameter display 24 is provided as an example of a display that displays plural setting display elements on the display screen.

The parameter setting unit 25 sets one of the parameters transmitted from the parameter acquiring unit 23 as a default parameter for the setting item of the function represented by the function icon. Further, notified by the icon drag detecting unit 21 that the function icon has been dragged onto a parameter icon, the parameter setting unit 25 writes the parameter represented by the parameter icon over the default parameter set for the setting item of the function represented by the function icon corresponding to the parameter. In the present exemplary embodiment, the parameter setting unit 25 is provided as an example of a setting unit that sets a setting information item for a setting item of a function.

The icon drop detecting unit 26 detects a user operation of dropping the function icon on the operation panel 15. Upon drop of the function icon, the icon drop detecting unit 26 notifies the function executing unit 27 of the drop of the function icon. In the present exemplary embodiment, the drop operation is used as an example of a release operation of releasing the state in which the function display element is pointed by the pointing unit, and the icon drop detecting unit 26 is provided as an example of a release operation detector that detects the release operation.

Notified by the icon drop detecting unit 26 that the function icon has been dropped, the function executing unit 27 executes the function represented by the function icon by using the parameter set by the parameter setting unit 25. In the present exemplary embodiment, the function executing unit 27 is provided as an example of an executing unit that executes the function and as an example of a controller that performs a control to cause the image processing unit to execute the function.

These functional units are realized by the cooperation of software and hardware resources. Specifically, a program realizing the icon drag detecting unit 21, the parameter area display 22, the parameter acquiring unit 23, the parameter display 24, the parameter setting unit 25, the icon drop detecting unit 26, and the function executing unit 27 is read into the RAM 12 from the HDD 14, for example, and executed by the CPU 11, to thereby realize these functional units.

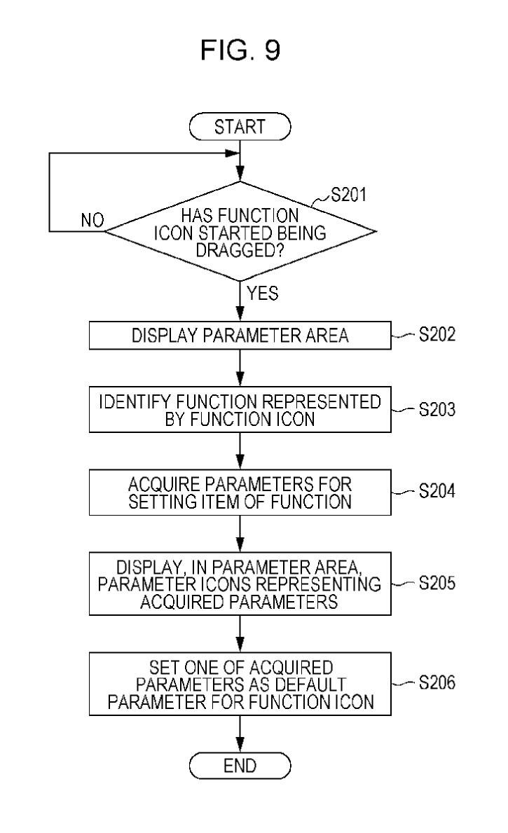

An operation of the image processing apparatus 10 in the present exemplary embodiment will now be described. FIG. 9 is a flowchart illustrating an operation example performed when the image processing apparatus 10 displays parameter icons. As illustrated in the drawing, in the image processing apparatus 10, the icon drag detecting unit 21 first determines whether or not a function icon has started being dragged on the operation panel 15 (step S201). If it is determined that a function icon has not started being dragged, the icon drag detecting unit 21 continues to wait for the start of the drag at step S201. If it is determined that a function icon has started being dragged, the parameter area display 22 displays a parameter area on the operation panel 15 (step S202). Further, the parameter acquiring unit 23 identifies the function represented by the function icon (step S203), and acquires parameters for a setting item of the function (step S204). Then, the acquired parameters are transmitted to the parameter display 24, and the parameter display 24 displays parameter icons representing the acquired parameters in the parameter area on the operation panel 15 (step S205). In this step, the parameter display 24 notifies the icon drag detecting unit 21 of the respective display positions of the parameter icons on the operation panel 15. Meanwhile, the acquired parameters are also transmitted to the parameter setting unit 25, and the parameter setting unit 25 sets one of the acquired parameters as a default parameter for the setting item of the function represented by the function icon (step S206).

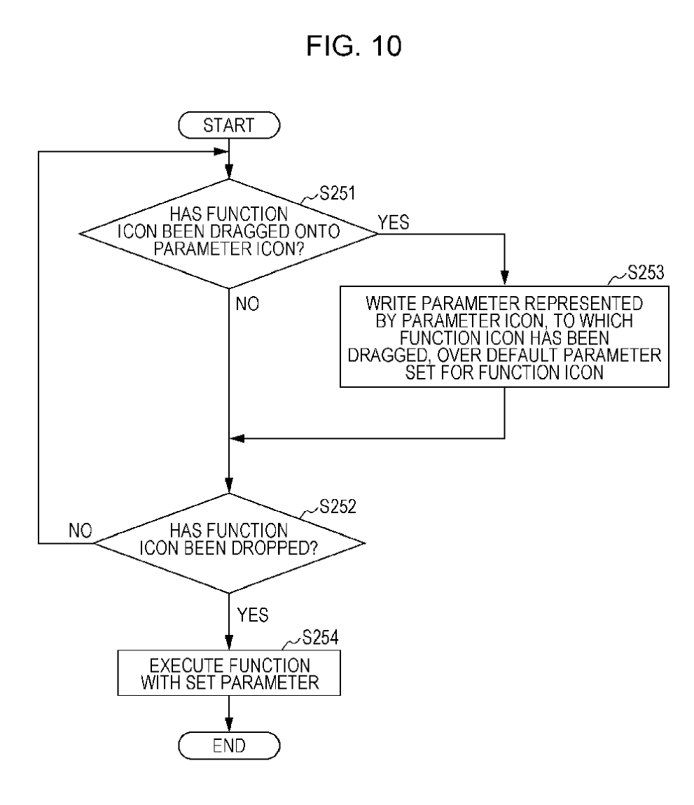

FIG. 10 is a flowchart illustrating an operation example performed when the image processing apparatus 10 sets a parameter. As illustrated in the drawing, the icon drag detecting unit 21 determines whether or not a function icon has been dragged onto a parameter icon (step S251). Specifically, the icon drag detecting unit 21 performs the determination by comparing the display position of each of the parameter icons transmitted from the parameter display 24 with the display position of the function icon controlled by the icon drag detecting unit 21. If it is then determined that the function icon has not been dragged onto any of the parameter icons, the icon drop detecting unit 26 determines whether or not the function icon has been dropped (step S252). Meanwhile, if it is determined that the function icon has been dragged onto one of the parameter icons, the parameter setting unit 25 writes the parameter represented by the parameter icon determined at step S251 as the parameter icon onto which the function icon has been dragged over the parameter set at step S206 for the setting item of the function represented by the function icon (step S253). Then, the icon drop detecting unit 26 determines whether or not the function icon has been dropped (step S252). If it is determined at step S252 that the function icon has not been dropped, the procedure returns to step S251. Further, if it is determined at step 252 that the function icon has been dropped, the function executing unit 27 executes the function by using the parameter set by the parameter setting unit 25 at step S206 and not overwritten at step S253 or by using the parameter overwritten by the parameter setting unit 25 at step S253 (step S254).

The program realizing the present exemplary embodiment may be provided as stored in a recording medium, such as a compact disc (CD)-ROM, let alone by a communication unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a moving operation detector that detects a moving operation of moving a function display element while pointing the function display element with a pointing unit, on a display screen displaying the function display element being a display element representing a function of the apparatus;
an acquiring unit that acquires a plurality of setting information items for a setting item of the function in accordance with the detection of the moving operation by the moving operation detector;
a display that displays on the display screen the plurality of setting display elements being a plurality of display elements representing the plurality of setting information items; and
a setting unit that, in accordance with the detection by the moving operation detector that the function display element has reached a position on one of the plurality of setting display elements, sets the setting information item represented by the setting display element for the setting item of the function.

2. The information processing apparatus according to claim 1, wherein the acquiring unit acquires the plurality of setting information items for each of a plurality of setting items of the function, and
wherein the display displays the plurality of setting display elements for each of the plurality of setting items.

3. The information processing apparatus according to claim 2, wherein the setting unit presets one of the plurality of setting information items for each of the plurality of setting items, and
wherein, in accordance with the detection by the moving operation detector that the function display element has reached a position on one of the plurality of setting display elements, the setting unit sets the setting information item represented by the setting display element in place of the preset setting information item.

4. The information processing apparatus according to claim 2, wherein the display displays the plurality of setting display elements in a display area which hides a portion of the display screen from a first side corresponding to one side of the display screen to a second side located between the one side of the display screen and an opposite side of the display screen opposite to the one side, and which is increased in area as the second side moves away from the first side in accordance with the movement of the function display element from the second side toward the first side.

5. The information processing apparatus according to claim 3, wherein the display displays the plurality of setting display elements in a display area which hides a portion of the display screen from a first side corresponding to one side of the display screen to a second side located between the one side of the display screen and an opposite side of the display screen opposite to the one side, and which is increased in area as the second side moves away from the first side in accordance with the movement of the function display element from the second side toward the first side.

6. The information processing apparatus according to claim 1, further comprising:
a release operation detector that detects a release operation of releasing the state in which the function display element is pointed by the pointing unit; and
an executing unit that executes the function by using the setting information item set by the setting unit, when the release operation is detected by the release operation detector with the function display element present on one or none of the plurality of setting display elements.

7. The information processing apparatus according to claim 2, further comprising:
a release operation detector that detects a release operation of releasing the state in which the function display element is pointed by the pointing unit; and
an executing unit that executes the function by using the setting information item set by the setting unit, when the release operation is detected by the release operation detector with the function display element present on one or none of the plurality of setting display elements.

8. The information processing apparatus according to claim 3, further comprising:
a release operation detector that detects a release operation of releasing the state in which the function display element is pointed by the pointing unit; and
an executing unit that executes the function by using the setting information item set by the setting unit, when the release operation is detected by the release operation detector with the function display element present on one or none of the plurality of setting display elements.

9. The information processing apparatus according to claim 4, further comprising:
a release operation detector that detects a release operation of releasing the state in which the function display element is pointed by the pointing unit; and
an executing unit that executes the function by using the setting information item set by the setting unit, when the release operation is detected by the release operation detector with the function display element present on one or none of the plurality of setting display elements.

10. The information processing apparatus according to claim 5, further comprising:
a release operation detector that detects a release operation of releasing the state in which the function display element is pointed by the pointing unit; and
an executing unit that executes the function by using the setting information item set by the setting unit, when the release operation is detected by the release operation detector with the function display element present on one or none of the plurality of setting display elements.

11. An image processing apparatus comprising:
an image processing unit that performs image processing on the basis of input image data;
a moving operation detector that detects a moving operation of moving a function display element while pointing the function display element with a pointing unit, on a display screen displaying the function display element being a display element representing a function of the image processing unit;
an acquiring unit that acquires a plurality of setting information items for a setting item of the function in accordance with the detection of the moving operation by the moving operation detector;
a display that displays on the display screen the plurality of setting display elements being a plurality of display elements representing the plurality of setting information items;
a setting unit that, in accordance with the detection by the moving operation detector that the function display element has reached a position on one of the plurality of setting display elements, sets the setting information item represented by the setting display element for the setting item of the function;
a release operation detector that detects a release operation of releasing the state in which the function display element is pointed by the pointing unit; and
a controller that, in accordance with the detection of the release operation by the release operation detector, performs a control to cause the image processing unit to execute the function by using the setting information item set by the setting unit.

12. A computer readable medium storing a program causing a computer to execute a process for information processing, the process comprising:
detecting a moving operation of moving a function display element while pointing the function display element with a pointing unit, on a display screen displaying the function display element being a display element representing a function of an apparatus;
acquiring a plurality of setting information items for a setting item of the function in accordance with the detection of the moving operation;
displaying on the display screen the plurality of setting display elements being a plurality of display elements representing the plurality of setting information items; and
setting, in accordance with the detection that the function display element has reached a position on one of the plurality of setting display elements, the setting information item represented by the setting display element for the setting item of the function.

13. An information processing method comprising:
detecting a moving operation of moving a function display element while pointing the function display element with a pointing unit, on a display screen displaying the function display element being a display element representing a function of an apparatus;
acquiring a plurality of setting information items for a setting item of the function in accordance with the detection of the moving operation;
displaying on the display screen the plurality of setting display elements being a plurality of display elements representing the plurality of setting information items; and
setting, in accordance with the detection that the function display element has reached a position on one of the plurality of setting display elements, the setting information item represented by the setting display element for the setting item of the function.
